(19) United States
(12) Patent Application Publication
(10) Pub. No.: US 2011/0149297 A1
(43) Pub. Date: Jun. 23, 2011

(54) Maskless exposure apparatus and multi-head alignment method thereof

(75) Inventors: Sang Hyun Park, Yongin-si (KR); Hi Kuk Lee, Yongin-si (KR); Sang Don Jang, Suwon-si (KR); Oui Serg Kim, Seongnam-si (KR); Dong Seok Baek, Suwon-si (KR)

(73) Assignee: Samsung Electronics Co., Ltd.

(21) Appl. No.: 12/926,881

(22) Filed: Dec. 15, 2010

(30) Foreign Application Priority Data
Dec. 22, 2009 (KR) 10-2009-0129358

(51) Int. Cl. G01B 11/02

(52) U.S. Cl. 356/500

(57) ABSTRACT

Example embodiments are directed to a mask-less exposure apparatus configured to expose a pattern on a substrate using a light modulation device and a multi-head alignment method thereof. According to example embodiments, a beam measurement device measures positions and focuses of at least three beams from among a plurality of beams emitted from multiple heads, the measurement enabling alignment of a position and an angle of a lens barrel deviated from a reference position according to an error in position and focus of the measured at least three beams.

### CROSS-REFERENCE TO RELATED APPLICATION

This application claims priority under 35 U.S.C. §119 to Korean Patent Application No. 2009-0129358, filed on Dec. 22, 2009 in the Korean Intellectual Property Office, the entire disclosure of which is incorporated herein by reference.

### BACKGROUND

1. Field

Example embodiments relate to a mask-less exposure apparatus to expose a pattern on a substrate using a light modulation device and an alignment method thereof.

2. Description of the Related Art

In general, a method of forming a pattern on a substrate of a Flat Panel Display (FPD), such as a liquid crystal display or plasma display, is as follows. First, a substrate is coated with a pattern material and then, the pattern material is selectively exposed by use of a photo-mask. As chemical properties of a part of the pattern material are changed by the selective exposure, the chemically changed part or the remaining part of the pattern material is selectively removed, completing formation of a pattern.

As the size of a substrate increases and a pattern to be formed on an exposure plane requires increased precision, manufacturing costs of a photo-mask increase. A mask-less exposure apparatus not using a photo-mask may achieve reduced costs.

In a mask-less exposure apparatus, a lens barrel, on which an exposure head is installed, is used to guide a beam of light to a substrate for irradiation of the substrate. The lens barrel may need not only an illumination optical system, but also a two-stage projection optical system that converges a beam focus or extends a beam interval. Accordingly, the lens barrel in the mask-less exposure apparatus is generally longer than other lens barrels in general exposure apparatuses.

A light modulation device, such as a Digital Micro-mirror Device (DMD), generally has a small light irradiation area and has a limit in exposure width even with light expansion. Therefore, a large number of lens barrels may be installed to organize multiple exposure heads, so as to obtain large-area exposure via stitching of small exposure patterns. This may require a reduced interval between lens barrels of an optical system and a reduced outer diameter of each lens barrel, causing an increase in the aspect ratio of a length to a diameter of the lens barrel. The resulting lens barrel is susceptible to bending and/or distortion, thus exhibiting posture variation in the course of an exposure process.

The posture variation of the lens barrel has an effect on stitching performance on a plane. Also, if a beam focus deviates from an allowable position range due to a rotation error, this may deteriorate exposure quality of a substrate having undergone a final exposure process. Therefore, it may be necessary to periodically correct the posture of a beam guiding lens barrel.

### SUMMARY

According to example embodiments, a mask-less exposure apparatus, includes a stage configured to move a substrate; a multi-optical system configured to irradiate beams on the substrate to expose a pattern on the substrate; a plurality of lens barrels configured to guide the beams emitted from the multi-optical system to the substrate; a lens barrel drive unit configured to drive the plurality of lens barrels; a beam measurement device configured to measure positions of the beams; and a control unit configured to control the lens barrel drive unit to align positions and angles of the plurality of lens barrels according to errors in position of the beams measured by the beam measurement device, the errors resulting from a deviation of the beam measurement device from a reference position.

According to example embodiments, the mask-less exposure apparatus, further includes a first laser interferometer configured to measure a position of the stage; and a second laser interferometer configured to measure a position of the beam measurement device, wherein the beam measurement device includes a plurality of reflector mirrors that reflect lasers emitted respectively from the first laser interferometer and the second laser interferometer.

According to example embodiments, one of the plurality of reflector mirrors is on one side of the beam measurement device and a second reflector mirror is on a side of the beam measurement device opposite from the first reflector mirror.

According to example embodiments, the control unit synchronizes a position precision of the beam measurement device with a position precision of the stage by coinciding a scale of the laser emitted from the first laser interferometer with a scale of the laser emitted from the second laser interferometer.

According to example embodiments, the mask-less exposure apparatus, further includes a master glass including a plurality of correction marks, wherein the beam measurement device measures the plurality of correction marks, and the control unit corrects an X-axis direction straightness of the beam measurement device according to position errors of the measured correction marks, the position errors resulting from a deviation of the beam measurement device from a reference position.

According to example embodiments, the beam measurement device measures positions and focuses of some beams from among all beams emitted from at least one of the plurality of lens barrels, and beams defining an exposure plane; and the control unit controls the lens barrel drive unit to align a position and an angle of the at least one lens barrel according to an error in position and focus of the measured some beams.

According to example embodiments, a multi-head alignment method of a mask-less exposure apparatus includes synchronizing a position precision of a beam measurement device with a position precision of a stage; correcting a straightness of the beam measurement device; measuring positions and focuses of at least three beams from a plurality of beams emitted from at least one lens barrel and defining a spatial imaginary plane; and aligning a position and an angle of the at least one lens barrel according to an error in position and focus of the measured at least three beams.

According to example embodiments, the synchronization of the position precision of the beam measurement device includes coinciding a laser scale of a first laser interferometer that measures a position of the stage with a laser scale of a second laser interferometer that measures a position of the beam measurement device.

According to example embodiments, the correction of the straightness of the beam measurement device includes: measuring a plurality of correction marks on a master glass, storing position errors of the measured correction marks resulting from a deviation of the correction marks from a reference position, and correcting positions of the measured beams according to the stored position errors.

According to example embodiments, the measured some beams include beams located near corners of the spatial imaginary plane.

According to example embodiments, the position and focus errors of the measured some beams are used to calculate spatial correction coordinate values such that the spatial imaginary plane and a reference plane are parallel to each other within an offset range or the spatial imaginary plane and the reference plane coincide with each other; and the alignment of the position and the angle of the lens barrel includes driving the lens barrel according to the calculated spatial correction coordinate values.

According to example embodiments, the alignment of the position and the angle of the lens barrel includes: manually driving a lens barrel drive unit based on the error in position and focus of the beams measured by the beam measurement device, the error resulting from a deviation of the beam measurement device from a reference position.

### BRIEF DESCRIPTION OF THE DRAWINGS

The above and other features and advantages will become more apparent by describing in detail example embodiments with reference to the attached drawings. The accompanying drawings are intended to depict example embodiments and should not be interpreted to limit the intended scope of the claims. The accompanying drawings are not to be considered as drawn to scale unless explicitly noted.

FIG. 1 is a perspective view of a mask-less exposure apparatus according to example embodiments;

FIG. 2 is a plan view of the mask-less exposure apparatus of FIG. 1;

FIG. 3 is a view illustrating operation of multiple exposure heads according to example embodiments;

FIG. 4 is a perspective view illustrating a beam measurement device according to example embodiments;

FIG. 5 is a control block diagram of the mask-less exposure apparatus according to example embodiments;

FIG. 6 is a plan view illustrating correction of X-axis direction straightness of the beam measurement device according to example embodiments;

FIG. 7 is a view illustrating a position error of a correction mark measured by the beam measurement device according to example embodiments;

FIG. 8 is a view illustrating measurement of some beams using the beam measurement device according to example embodiments;

FIG. 9 is a view illustrating an imaginary plane defined by measuring some beams according to example embodiments;

FIG. 10 is a view illustrating an offset range on the basis of a reference plane determined by a user according to example embodiments; and

FIG. 11 is a flow chart illustrating a multi-head alignment method of the mask-less exposure device according to example embodiments.

### DETAILED DESCRIPTION

Reference Detailed example embodiments are disclosed herein. However, specific structural and functional details disclosed herein are merely representative for purposes of describing example embodiments. Example embodiments may, however, be embodied in many alternate forms and should not be construed as limited to only the embodiments set forth herein.

Accordingly, while example embodiments are capable of various modifications and alternative forms, embodiments thereof are shown by way of example in the drawings and will herein be described in detail. It should be understood, however, that there is no intent to limit example embodiments to the particular forms disclosed, but to the contrary, example embodiments are to cover all modifications, equivalents, and alternatives falling within the scope of example embodiments. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments. As used herein, the term “and/or” includes any and all combinations of one or more of the associated listed items.

It will be understood that when an element is referred to as being “connected” or “coupled” to another element, it may be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between”, “adjacent” versus “directly adjacent”, etc.).

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

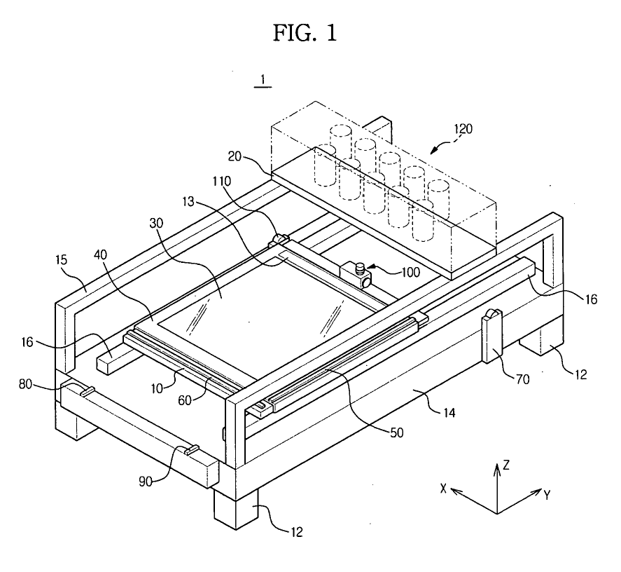

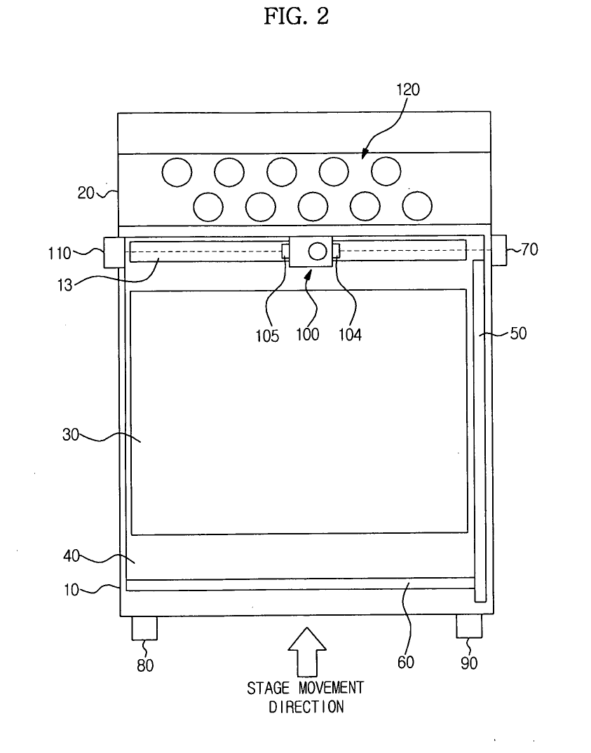

As illustrated in FIGS. 1 and 2, a mask-less exposure apparatus 1 according to example embodiments includes a reference surface-plate or frame 14 supported by anti-vibration legs 12, a stage 10 movably placed on the reference surface-plate or frame 14, and a chuck 40 placed on and fixed to the stage 10 to secure a substrate 30 to be exposed.

The stage 10 is provided at opposite sides thereof with guides 16 extending in a stage movement direction. A first bar mirror 50 and a second bar mirror 60 are installed on the stage 10 such that the first bar mirror 50 extends in the stage movement direction and the second bar mirror 60 extends in a direction orthogonal to the first bar mirror 50.

A head supporting plate 20 is coupled to a stage gantry 15 to support multiple exposure heads 120 constituting a multi-optical system. When beams emitted from a light source (not shown) are spatially modulated by a light modulation device such as a DMD, the multiple exposure heads 120 receive the spatially modulated beams so as to irradiate the beams on the substrate 30.

A first laser interferometer 70 is installed at one side of the first bar mirror 50 to measure a position of the stage 10 in the stage movement direction (hereinafter, referred to as a Y-axis direction). Second and third laser interferometers 80 and 90 are installed at one side of the second bar mirror 60 to measure a position of the stage 10 in a direction orthogonal to the Y-axis direction (hereinafter, referred to as an X-axis direction).

A control unit, which will be described hereinafter, controls a position of the stage 10 by use of the first to third laser interferometers 70, 80 and 90 during movement of the stage 10.

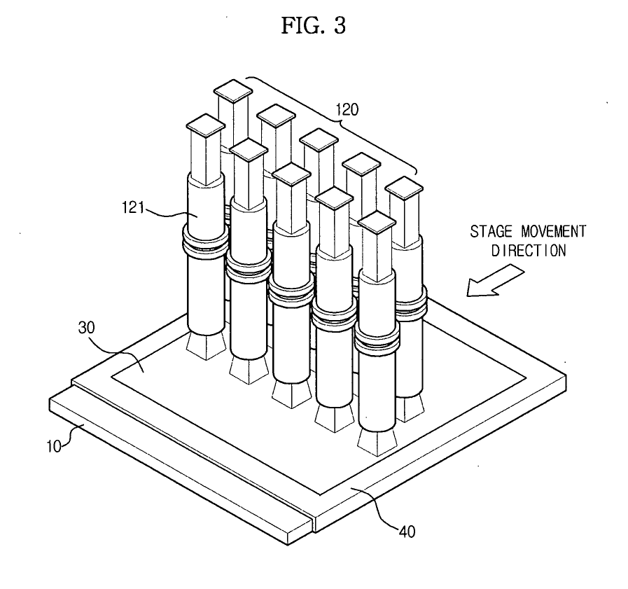

As illustrated in FIG. 3, the multiple exposure heads 120 installed on a plurality of lens barrels 121 irradiate beams to the substrate 30. A position and angle of each lens barrel 121 may slight vary and in turn, the posture variation of the lens barrel 121 may change a position and depth of focus of a beam guided by the lens barrel 121. This may affect an exposure quality, requiring position and angle alignment of the lens barrel 121.

A beam measurement device 100 is installed and fixed to the stage 10.

The beam measurement device 100 is provided at opposite sides thereof with first and second reflector mirrors 104 and 105. The first reflector mirror 104 reflects laser emitted from the first laser interferometer 70, and the second reflector mirror 105 reflects laser emitted from a fourth laser interferometer 110.

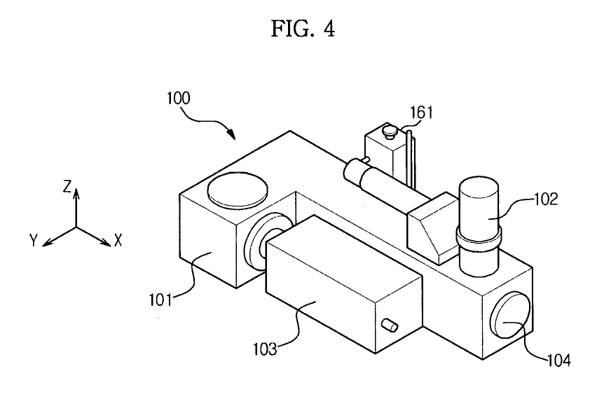

As illustrated in FIG. 4, the beam measurement device 100 includes an objective lens 102 installed on a body 101 to project the beams emitted from the multiple exposure heads 120, and a charge coupled device (CCD) camera 103 to photograph the beams projected by the objective lens 102.

The beam measurement device 100 is movable in X-axis, Y-axis and Z-axis directions to measure the beams. In particular, a Z-axis drive unit 161 is used to move the beam measurement device 100 in the Z-axis direction so as to measure the depth of focus of a beam.

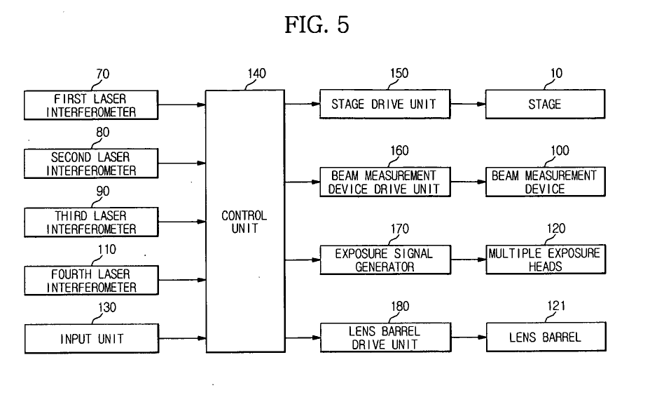

FIG. 5 is a control block diagram of the mask-less exposure apparatus according to example embodiments.

An input unit 130 inputs an exposure mode (X-axis and Y-axis stage movement distances, scan number, scan velocity, etc.) to a control unit 140, to expose a pattern on the substrate 30.

The control unit 140 controls a stage drive unit 150 to move the stage 10.

The control unit 140 outputs a control signal for exposure of pattern based on the input exposure mode to an exposure signal generator 170. The exposure signal generator 170 generates an exposure signal corresponding to the pattern and provides the exposure signal to the multiple exposure heads 120. The multiple exposure heads 120 irradiate beams on the substrate 30, realizing exposure of the pattern.

During movement of the stage 10, the control unit 140 feeds back X-axis and Y-axis positions of the stage 10 from the first to third laser interferometers 70, 80 and 90, so as to control the stage drive unit 150.

The beam measurement device 100 may measure beam positions periodically and/or during an exposure process to align the posture of the lens barrel 121. The control unit 140 controls a beam measurement device drive unit 160 so that the beam measurement device 100 performs beam measurement while being moved in X-axis, Y-axis and Z-axis directions. The control unit 140 controls a lens barrel drive unit 180 according to beam measurement results for alignment of X-axis, Y-axis and Z-axis positions of the lens barrel 121.

Although example embodiments describe the lens barrel drive unit 180 as being controlled by the control unit 140, example embodiments are not limited thereto. According to example embodiments, a user may be informed of the beam measurement results, so that the user may align the posture of the lens barrel 121 by manually driving the lens barrel drive unit 180.

Since a position precision (scale) of the stage 10 may determine a precision (scale) of the entire exposure process, it may be necessary to control driving of the beam measurement device 100 in synchronization with a driving precision of the stage 10.

A method of synchronizing an X-axis driving precision of the beam measurement device 100 with the driving precision of the stage 10 is as follows. First, the stage 10 is moved in the Y-axis direction so that the first laser interferometer 70 and the fourth laser interferometer 110 are aligned with each other in a straight line. As a result, the first laser interferometer 70 and the first reflector mirror 104 of the beam measurement device 100 face each other, and the fourth laser interferometer 110 and the second reflector mirror 105 of the beam measurement device 100 face each other. Then, while the beam measurement device 100 is moved in the X-axis direction from a reference position thereof, a measured scale of laser emitted from the first laser interferometer 70 and reflected by the first reflector mirror 104 is compared with a measured scale of laser emitted from the fourth laser interferometer 110 and reflected by the second reflector mirror 105. If absolute values of the measured scales differ from each other, the control unit 140 corrects a wavelength value of the fourth laser interferometer 110, enabling alignment of the X-axis driving precision. This alignment may be performed linearly or non-linearly according to a movement section of the beam measurement device 100.

The Y-axis driving of the beam measurement device 100 is synchronized with the Y-axis driving of the stage 10 because the beam measurement device 100 is installed to the stage 10.

After completion of the synchronization of the beam measurement device 100 and the stage 10, correction of X-axis direction straightness of the beam measurement device 100 is performed.

Y-axis direction straightness of the beam measurement device 100 follows Y-axis direction straightness of the stage 10 and thus, correction thereof may be unnecessary.

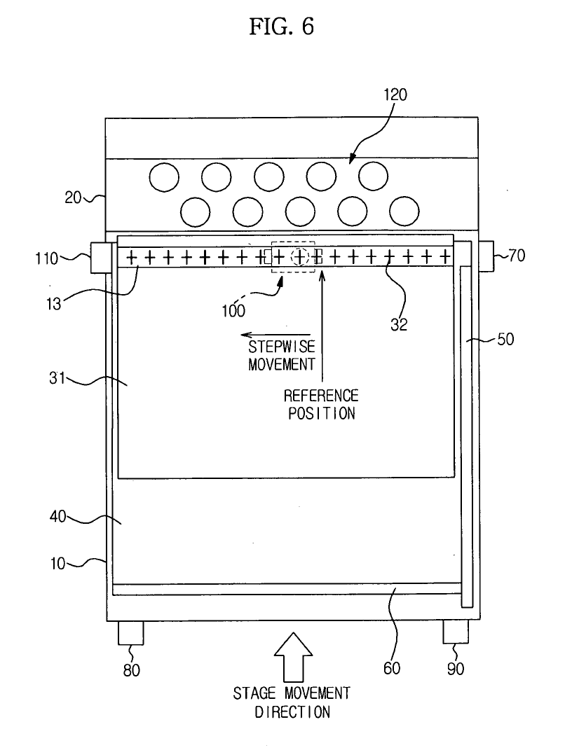

FIG. 6 is a plan view illustrating correction of X-axis direction straightness of the beam measurement device 100 according to example embodiments.

In FIG. 6, a master glass 31 is fixed above the chuck 40. In this case, the chuck 40 has an observation window in the form of a slit 13, so that the beam measurement device 100 located below the chuck 40 may measure correction marks 32 of the master glass 31 through the slit 13.

The beam measurement device 100 measures the plurality of correction marks 32 by use of the CCD camera 103 while being moved stepwise in the X-axis direction from the reference position.

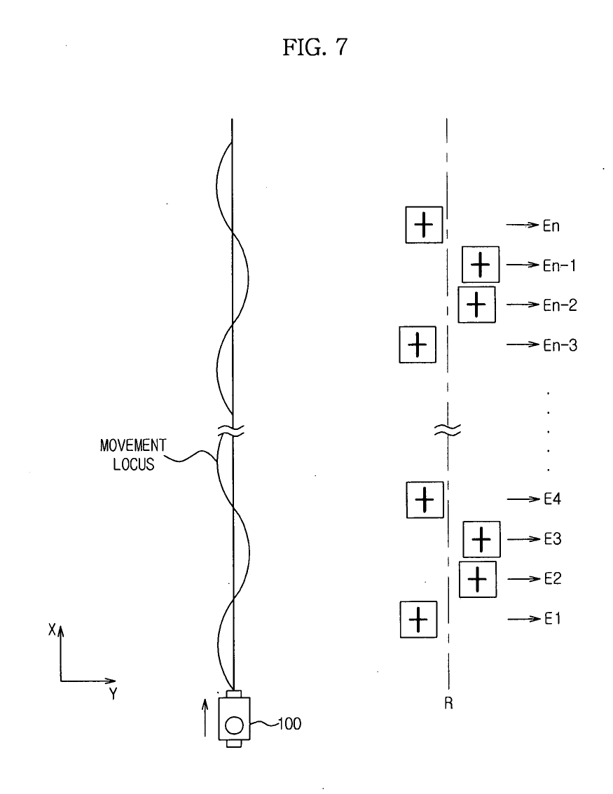

As illustrated in FIG. 7, in the case where the beam measurement device 100 measures the plurality of correction marks 32 while being moved in the X-axis direction (designated by the arrows), measured positions of the correction marks 32 may deviate from a reference position R depending on a movement locus of the beam measurement device 100. The control unit 140 stores position errors E₁, E₂ . . . , Eₙ of the respective correction marks 32 deviated from the reference position R.

In this way, the X-axis direction straightness of the beam measurement device 100 may be directly corrected by applying the stored position errors to the measured beam positions during next beam measurement, or may be corrected by driving the beam measurement device 100 in the Y-axis direction based on the position errors during the next beam measurement.

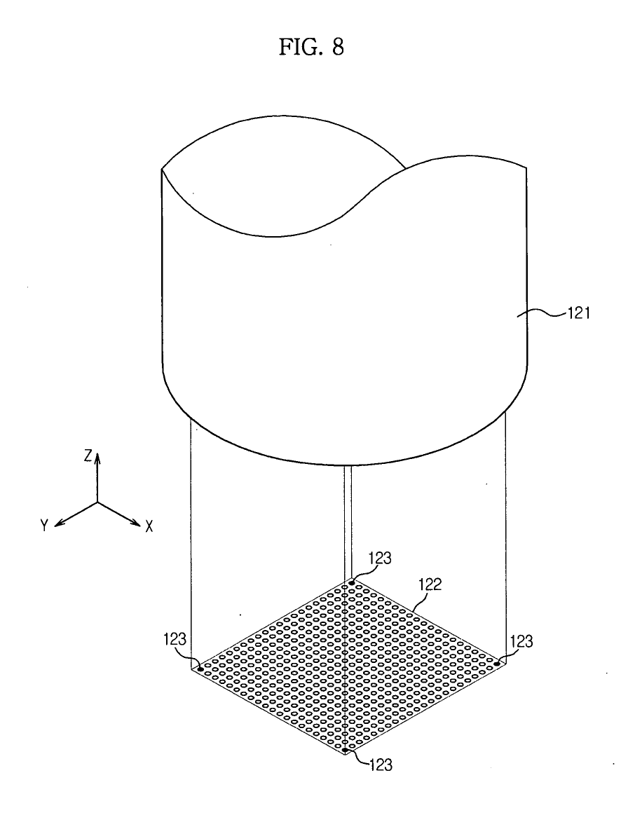

As illustrated in FIG. 8, an exposure plane 122 is defined by a plurality of beams emitted from the single lens barrel 121. Therefore, when the beam measurement device 100 attempts to correct the posture of the lens barrel 121 by measuring positions and depths of focuses of all beams of the exposure plane 122, this may require a long time.

In a method according to example embodiments, instead of measuring all of the beams of the exposure plane 122, some (for example, at least three) beams 123, which correspond to four corners of an imaginary plane 124 in space, are selected and then, positions and depths of focuses of the beams 123 are measured, so that the posture of the lens barrel 121 may be corrected using the measured values and rotation error values. Here, the number and positions of beams to be measured may be changed.

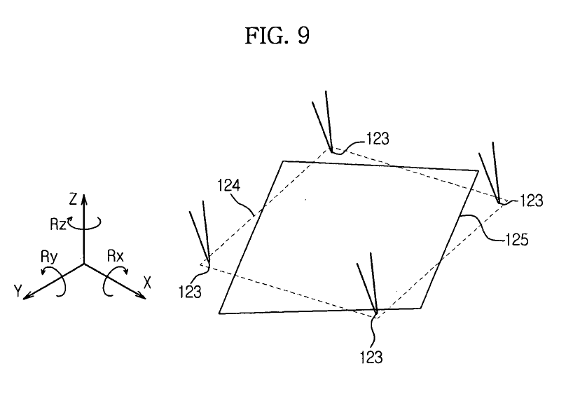

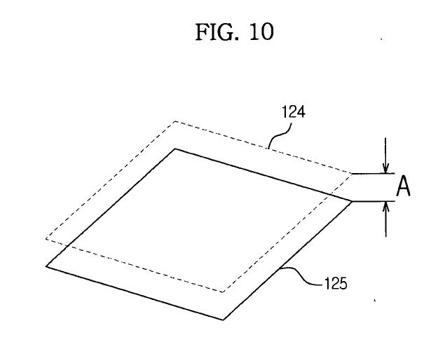

As illustrated in FIG. 9, the imaginary plane 124 defined by the four beams 123 may deviate from a reference plane 125 determined by a user. Therefore, it may be necessary to calculate spatial correction coordinate values Δx, Δy, Δz, ΔRx, ΔRy and ΔRz in order to allow the two planes to be parallel to each other within an offset range (for example, ‘A’ in FIG. 10) determined by the user on the basis of options, such as depth of focus and auto focus of the head as illustrated in FIG. 10 or to coincide with each other.

As the control unit 140 controls the lens barrel drive unit 180 according to the correction coordinate values Δx, Δy, Δz, ΔRx, ΔRy and ΔRz or the user manually operates the lens barrel drive unit 180 to correct the position and angle of the lens barrel 121, correction of the position and depth of focus of the beams may be accomplished.

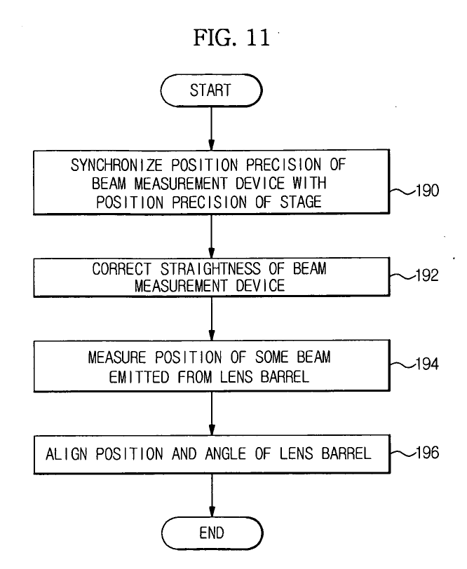

FIG. 11 is a flow chart illustrating a multi-head alignment method of the mask-less exposure device according to example embodiments.

In a state wherein the beam measurement device 100 is located between the first laser interferometer 70 and the fourth laser interferometer 110 as illustrated in FIG. 2, the scale of laser emitted from the first laser interferometer 70 used for detection of the Y-axis direction position of the stage 10 is compared with the scale of laser emitted from the fourth laser interferometer 110 for detection of the X-axis direction position of the beam measurement device 100. The wavelength value of laser of the fourth laser interferometer 110 is corrected according to the scale difference, allowing the position precision of the beam measurement device 100 to be synchronized with the position precision of the stage 10 (190).

The stage 10 is moved until the correction marks 32 arranged at one end of the master glass 31 in the X-axis direction are located above the slit 13 as illustrated in FIG. 6 and the beam measurement device 100 measures the correction marks 32 while being moved in the X-axis direction. Position errors of the respective correction marks 32 deviated from the reference position R are stored, so that the X-axis direction straightness of the beam measurement device 100 is corrected using the position errors. Since the beam measurement device 100 is installed to the stage 10, correction of Y-axis direction straightness of the beam measurement device 100 may be unnecessary (192).

Next, the beam measurement device 100 measures the four corner beams 123 from among all of the beams emitted from the lens barrel 121. A position error and rotation error of the imaginary plane 124 defined by the four measured beams are calculated when the imaginary plane 124 deviates from the reference plane 125 determined by the user beyond an allowable range, and correction coordinate values to correct spatial coordinate values of the measured beams are calculated (194).

Thereafter, as the control unit 140 controls the lens barrel drive unit 180 using the calculated correction coordinate values or the user manually drives the lens barrel drive unit 180 to correct the position and angle of the lens barrel 121, the posture of the lens barrel 121 may be corrected (196).

As is seen from the description above, according to example embodiments, a beam measurement device only measures some of beams emitted from a lens barrel to align a position of the lens barrel, resulting in shortened alignment time. Further, according to example embodiments, it is possible to coincide a scale of a laser interferometer used for position detection of the beam measurement device with a scale of a laser interferometer used for position detection of a stage. Accordingly, straightness of the beam measurement device may be corrected to the level of a master glass by synchronizing the beam measurement device and measuring correction marks of the master glass.

Example embodiments having thus been described, it will be obvious that the same may be varied in many ways. Such variations are not to be regarded as a departure from the intended spirit and scope of example embodiments, and all such modifications as would be obvious to one skilled in the art are intended to be included within the scope of the following claims.

What is claimed is:

1. A mask-less exposure apparatus, comprising:
a stage configured to move a substrate;
a multi-optical system configured to irradiate beams on the substrate to expose a pattern on the substrate;
a plurality of lens barrels configured to guide the beams emitted from the multi-optical system to the substrate;
a lens barrel drive unit configured to drive the plurality of lens barrels;
a beam measurement device configured to measure positions of the beams; and
a control unit configured to control the lens barrel drive unit to align positions and angles of the plurality of lens barrels according to errors in position of the beams measured by the beam measurement device, the errors resulting from a deviation of the beam measurement device from a reference position.

2. The mask-less exposure apparatus according to claim 1, further comprising:
a first laser interferometer configured to measure a position of the stage; and
a second laser interferometer configured to measure a position of the beam measurement device,
wherein the beam measurement device includes a plurality of reflector mirrors that reflect lasers emitted respectively from the first laser interferometer and the second laser interferometer.

3. The mask-less exposure apparatus according to claim 2, wherein one of the plurality of reflector mirrors is on one side of the beam measurement device and a second reflector mirror is on a side of the beam measurement device opposite from the first reflector mirror.

4. The mask-less exposure apparatus according to claim 2, wherein the control unit synchronizes a position precision of the beam measurement device with a position precision of the stage by coinciding a scale of the laser emitted from the first laser interferometer with a scale of the laser emitted from the second laser interferometer.

5. The mask-less exposure apparatus according to claim 2, further comprising a master glass including a plurality of correction marks,
wherein the beam measurement device measures the plurality of correction marks, and the control unit corrects an X-axis direction straightness of the beam measurement device according to position errors of the measured correction marks, the position errors resulting from a deviation of the beam measurement device from a reference position.

6. The mask-less exposure apparatus according to claim 1, wherein:
the beam measurement device measures positions and focuses of some beams from among all beams emitted from at least one of the plurality of lens barrels, and beams defining an exposure plane; and
the control unit controls the lens barrel drive unit to align a position and an angle of the at least one lens barrel according to an error in position and focus of the measured some beams.

7. A multi-head alignment method of a mask-less exposure apparatus, the method comprising:
synchronizing a position precision of a beam measurement device with a position precision of a stage;
correcting a straightness of the beam measurement device;
measuring positions and focuses of at least three beams from a plurality of beams emitted from at least one lens barrel and defining a spatial imaginary plane; and
aligning a position and an angle of the at least one lens barrel according to an error in position and focus of the measured at least three beams.

8. The method according to claim 7, wherein the synchronization of the position precision of the beam measurement device includes coinciding a laser scale of a first laser interferometer that measures a position of the stage with a laser scale of a second laser interferometer that measures a position of the beam measurement device.

9. The method according to claim 7, wherein the correction of the straightness of the beam measurement device includes:
measuring a plurality of correction marks on a master glass,
storing position errors of the measured correction marks resulting from a deviation of the correction marks from a reference position, and
correcting positions of the measured beams according to the stored position errors.

10. The method according to claim 7, wherein the measured some beams include beams located near corners of the spatial imaginary plane.

11. The method according to claim 7, wherein:
the position and focus errors of the measured some beams are used to calculate spatial correction coordinate values such that the spatial imaginary plane and a reference plane are parallel to each other within an offset range or the spatial imaginary plane and the reference plane coincide with each other; and
the alignment of the position and the angle of the lens barrel includes driving the lens barrel according to the calculated spatial correction coordinate values.

12. The method according to claim 7, wherein the alignment of the position and the angle of the lens barrel includes:
manually driving a lens barrel drive unit based on the error in position and focus of the beams measured by the beam measurement device, the error resulting from a deviation of the beam measurement device from a reference position.
